(19) United States
(12) Patent Application Publication
(10) Pub. No.: US 2013/0028792 A1
(43) Pub. Date: Jan. 31, 2013

(54) EXHAUST PURIFICATION APPARATUS FOR ENGINE

(71) Applicants: Masakazu YANO, Ageo (JP); Tomofumi Nakashima, Ageo (JP); Tomoyuki Takeda, Ageo (JP); Takafumi Amano, Ageo (JP)

(72) Inventors: Masakazu YANO, Ageo (JP); Tomofumi Nakashima, Ageo (JP); Tomoyuki Takeda, Ageo (JP); Takafumi Amano, Ageo (JP)

(21) Appl. No.: 13/647,057

(22) Filed: Oct. 8, 2012

Related U.S. Application Data
(63) Continuation of application No. PCT/JP2010/071712, filed on Dec. 3, 2010.

(30) Foreign Application Priority Data
Apr. 9, 2010 (JP) 2010-090439

(51) Int. Cl. B01D 53/94

(52) U.S. Cl. 422/107; 422/119

(57) ABSTRACT

The exhaust purification apparatus including a control unit which estimates: a deposition amount of urea crystal in an exhaust system per unit time based on a dosing flow rate of a urea aqueous solution injected to the exhaust upstream side of a SCR converter and an exhaust gas temperature; and an accumulation amount of the urea crystal by sequentially integrating the deposition amount. The control unit further estimates: an amount of the urea crystal to be removed from the exhaust system per unit time according to the exhaust gas temperature; and an accumulation amount of the remaining urea crystal by sequentially subtracting the estimated amount, from the accumulation amount. When the accumulation amount is equal to or greater than a predetermined amount, it is determined that a timing to forcefully remove the accumulated urea crystal has arrived. Then, an alarm is activated and a forceful removing processing is performed by raising the exhaust gas temperature.

### TECHNICAL FIELD

This invention relates to an exhaust purification apparatus for selectively reducing and purifying nitrogen oxide (NOₓ) contained in exhaust gas that is exhausted by an engine.

### BACKGROUND ART

As an exhaust purification system for purifying NOₓ contained in exhaust gas that is exhausted by an engine, an exhaust purification apparatus such as the one disclosed in Japanese Laid-Open Patent Application Publication No. 2009-127472 (Patent Document 1) has been proposed. Such exhaust purification apparatus injects a urea aqueous solution into an exhaust gas that flows on the exhaust upstream side of a selective catalytic reduction (SCR) converter provided to an exhaust pipe of the engine, in accordance with an engine operating condition. Then, with use of ammonia generated by hydrolyzation thereof, the SCR converter selectively reduces NOₓ so that the NO is purified to be harmless components.

### CITATION LIST

### Patent Document

Patent Document 1: Japanese Laid-Open Patent Application Publication No. 2009-127472

### SUMMARY OF THE INVENTION

### Technical Problem

In the exhaust purification apparatus described above, when the exhaust temperature remains to be lower than a hydrolyzation temperature of the urea aqueous solution, the urea aqueous solution may be insufficiently hydrolyzed, and droplet of the urea aqueous solution may adhere to an exhaust system (such as exhaust pipe and SCR converter) located at the exhaust downstream side of a point at which the urea aqueous solution is injected. Then, when the exhaust gas temperature, for instance, is equal to or greater than a boiling point (approximately 100° C.) of a solvent (water) but less than a boiling point (approximately 135° C.) of a solute (urea) while the droplet of the urea aqueous solution remains adhering to the exhaust system, the solvent water may be vaporized from the urea aqueous solution, such that deposit of urea crystal may occurs in the exhaust system. If the deposits of the urea crystal occur in the exhaust system, a sectional area of an exhaust passage will be reduced. Then, for instance, reduction in output and fuel consumption may be caused due to increase in exhaust gas pressure. In addition, the deposits of a crystal of the urea aqueous solution in the SCR converter, which will lead to reduction in a contact area between the SCR converter and the exhaust gas, may cause reduction in purification efficiency of NOₓ.

In view of the above conventional problems, the present invention has an object to provide an exhaust purification apparatus for an engine with which, for instance, a timing to forcefully remove urea crystal is able to be understood by estimating an accumulation amount of the urea crystal accumulated in an exhaust system located at the exhaust downstream side of an injection point of a urea aqueous solution.

### Solution to Problem

Thus, an exhaust purification apparatus for an engine includes: an SCR converter provided to an exhaust pipe of the engine and adapted to selectively reduce and purify NOₓ with use of ammonium generated from a urea aqueous solution; a reducing agent injection device adapted to inject the urea aqueous solution into the exhaust gas that flows on the exhaust upstream side of the SCR converter at a flow rate that corresponds to an engine operating condition; a temperature sensor adapted to measure a temperature of exhaust gas that flows at the exhaust upstream side of the reducing agent injection device; and a control unit having a built-in computer. In the exhaust purification apparatus, the control unit: estimates a deposition amount of urea crystal to be deposited in an exhaust system per unit time, based on the exhaust gas temperature measured by the temperature sensor and the flow rate of the urea aqueous solution injected by the reducing agent injection device, the exhaust system being located at the exhaust downstream side of an injecting point of the urea aqueous solution; estimates an amount of the urea crystal to be removed from the exhaust system per unit time, based on the exhaust gas temperature measured by the temperature sensor; and estimates an accumulation amount of the urea crystal accumulated in the exhaust system, based on the deposition amount and the amount of the urea crystal to be removed per unit time.

### Advantageous Effects of Invention

It is possible to estimate the accumulation amount of the urea crystal accumulated in the exhaust system located at the exhaust downstream side of the injection point of the urea aqueous solution.

### BRIEF DESCRIPTION OF DRAWINGS

FIG. 1 is an overall arrangement of an exemplary exhaust purification apparatus;

FIG. 2 is a flow chart illustrating an exemplary control program;

FIG. 3 is a view explaining a deposition amount map for use in estimating a deposition amount of urea crystal per unit time; and

FIG. 4 is a view explaining an amount map for use in estimating an amount of the urea crystal to be removed per unit time.

### DESCRIPTION OF EMBODIMENTS

Exemplary embodiments according to the aspect of the invention will be described below in details with reference to the attached drawings.

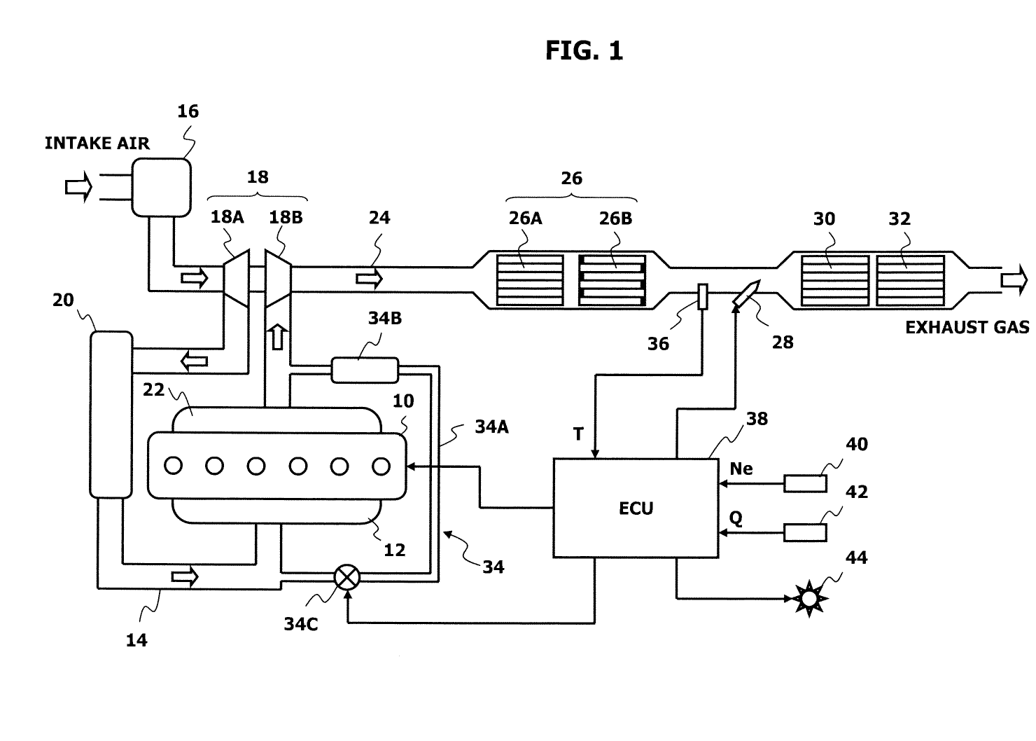

FIG. 1 illustrates an exemplary exhaust purification apparatus.

An intake pipe 14 connected to an intake manifold 12 of a diesel engine 10 is provided with: an air cleaner 16 adapted to filter dusts and the like in intake air; a compressor 18A of a turbo charger 18 adapted to supercharge the intake air; and an intercooler 20 adapted to cool the intake air that has been heated to a high temperature by passing through the turbo charger 18. The air cleaner 16, the compressor 18A and the intercooler 20 are provided to the intake pipe 14 in this order in a direction in which the intake air flows.

On the other hand, an exhaust pipe 24 connected to an exhaust manifold 22 of the diesel engine 10 is provided with: a turbine 18B of the turbocharger 18; a continuously regenerating diesel particulate filter (DPF) device 26; a reducing agent injection device 28 adapted to inject an urea aqueous solution; an SCR converter 30 adapted to selectively reduce and purify NOₓ with use of ammonia generated from hydrolyzation of the urea aqueous solution; and an oxidation catalyst converter 32 adapted to oxidize the ammonia having passed through the SCR converter 30. The turbine 18B, the continuously regenerating DPF device 26, the reducing agent injection device 28, the SCR converter 30 and the oxidation catalyst converter 32 are provided to the exhaust pipe 24 in this order in a direction in which the exhaust gas flows. The continuously regenerating DPF device 26 includes: a diesel oxidation catalyst (DOC) converter 26A adapted to at least oxidize nitrogen monoxide (NO) to nitrogen dioxide (NO₂); and a DPF 26B adapted to collect and eliminate particulate matters (PM) contained in the exhaust gas. In place of the DPF 26B, a catalyzed soot filter (CSF) on which surface a catalyst (active ingredients and dosing ingredients) is supported may be used. The reducing agent injection device 28 includes components such as a tank adapted to store the urea aqueous solution, a pump adapted to draw the urea aqueous solution from the tank to be pumped, a flow-rate control valve adapted to control an injection flow rate of the urea aqueous solution, and an injection nozzle adapted to inject the urea aqueous solution to the exhaust pipe 24, although the details thereof are not illustrated.

The diesel engine 10 is attached with an exhaust gas recirculation (EGR) system 34 adapted to reduce NOₓ by introducing and recirculating a part of the exhaust gas in the intake air and by decreasing the combustion temperature. The EGR system 34 includes: an EGR pipe 34A adapted to introduce into the intake pipe 14 a part of the exhaust gas flowing in the exhaust pipe 24; an EGR cooler 34B adapted to cool the exhaust gas flowing in the EGR pipe 34A; and an EGR control valve 34C adapted to control an EGR rate at which the exhaust gas is introduced into the intake pipe 14.

As a control system for the exhaust purification apparatus, a temperature sensor 36 is provided between the DPF 26B of the continuously regenerating DPF device 26 and the reducing agent injection device 28, and the temperature sensor 36 is adapted to measure a temperature (exhaust gas temperature) T of the exhaust gas that flows at the exhaust upstream side of the reducing agent injection device 28. The output signal from the temperature sensors 36 is input into a control unit 38 having a built-in computer. Into the control unit 38, the output signals are input respectively from a revolution speed sensor 40 for detecting a revolution speed Ne and a load sensor 42 for detecting a load Q, which are exemplary indication for the operating condition of the diesel engine 10. Examples of the load Q of the diesel engine 10 are properties closely associated with torque, such as a fuel feeding amount, a flow rate of the intake air, a pressure of the intake air, a supercharging pressure, an accelerator opening and a throttle opening. The revolution speed Ne and the load Q of the diesel engine 10 may be read from an engine control unit (not illustrated) adapted to electronically control the diesel engine 10 via a controller area network (CAN).

By running a control program stored in a nonvolatile memory such as a read only memory (ROM), the control unit 38 determines whether or not urea crystal has accumulated in an amount that exceeds an allowable amount, in an exhaust system located at the exhaust downstream side of the reducing agent injection device 28, that is, a position at which the urea aqueous solution is injected, based on the output signals respectively from the temperature sensor 36, the revolution speed sensor 40 and the load sensor 42. When determining that the urea crystal has accumulated in the exhaust system in the amount exceeding the allowable amount, the control unit 38 outputs a fuel increase command to a fuel injection device attached to the diesel engine 10 in order to forcefully remove the urea crystal by raising the exhaust temperature. At such time, the control unit 38 also controls an alarming lamp 44 (alarm) attached to an instrument cluster to be lightened. The “exhaust system” herein means a system at least including the exhaust pipe 24 and the SCR converter 30.

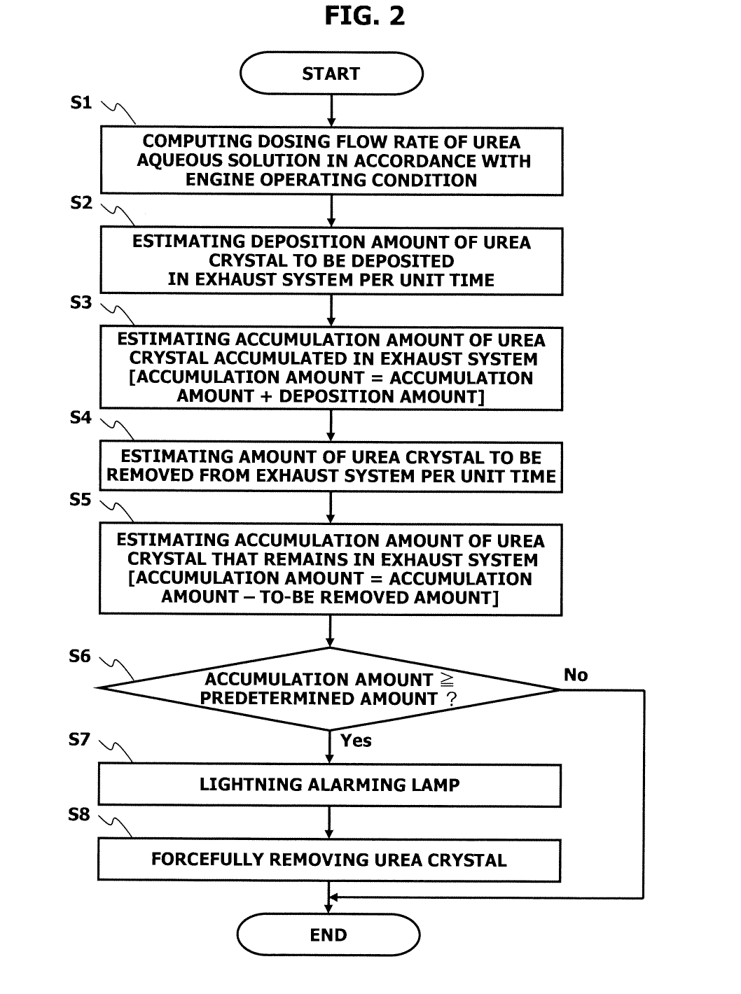

FIG. 2 illustrates the content of the control program that the control unit 38 repeatedly runs every unit time (e.g., every one second) upon the activation of the diesel engine 10. Incidentally, according to a control program that is different from the control program depicted in FIG. 2, the control unit 38 electronically controls the reducing agent injection device 28 and the EGR control valve 34C in accordance with the engine operating condition.

In step 1 (abbreviated as “S1” in the drawing, and same will be applied hereunder), the control unit 38 computes a dosing flow rate (injection amount per unit time) of the urea aqueous solution at which the urea aqueous solution is to be dosed in accordance with the engine operating condition. That is, the control unit 38 computes the dosing flow rate of the urea aqueous solution that corresponds to the revolution speed Ne detected by the revolution speed sensor 40 and to the load Q detected by the load sensor 42, with reference to, a map (not illustrated) that sets out the dosing flow rates corresponding to the revolution speeds and the loads. The dosing flow rate of the urea aqueous solution may be configured to be read from a module that electronically controls the reducing agent injection device 28.

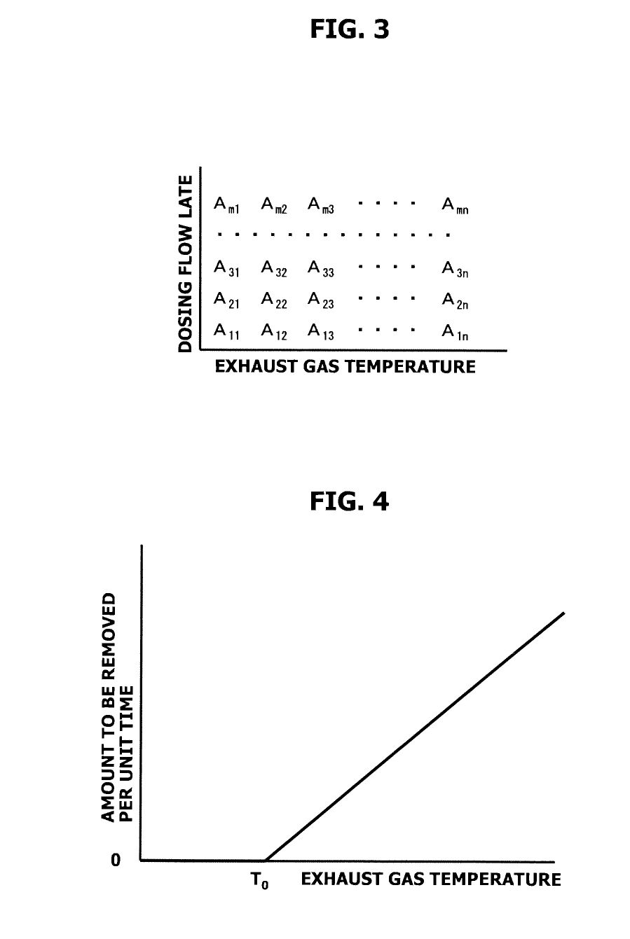

In step 2, the control unit 38 estimates a deposition amount of the urea crystal to be deposited in the exhaust system per unit time, based on the exhaust gas temperature and the dosing flow rate of the urea aqueous solution. That is, as illustrated in FIG. 3, the control unit 38 estimates the deposition amount of the urea crystal that corresponds to the exhaust gas temperature T measured by the temperature sensor 36 and the dosing flow rate of the urea aqueous solution, with reference to a deposition amount map (first map) that sets out the deposition amounts corresponding to the exhaust gas temperatures and the dosing flow rates. The deposition amount that corresponds to the exhaust gas temperature and the dosing flow rate may be obtained through, for instance, simulations or experiments (same will be applied hereunder).

In step 3, the control unit 38 estimates an accumulation amount of the urea crystal accumulated in the exhaust system, by utilizing a formula such as “accumulation amount=accumulation amount+deposition amount”.

In step 4, the control unit 38 estimates an amount of the urea crystal to be removed from the exhaust system per unit time, based on the exhaust gas temperature T measured by the temperature sensor 36. The “removing processing” herein means that the urea crystal accumulated in the exhaust system disappears from the exhaust system by melting or vaporization. That is, as illustrated in FIG. 4, the control unit 38 estimates the amount of the urea crystal to be removed that corresponds to the exhaust gas temperature T, with reference to an amount map of the urea crystal to be removed (second map) that sets out the amounts of the urea crystal to be removed corresponding to the exhaust gas temperatures. In the amount map, the amount of the urea crystal to be removed is set to “zero,” which means that no urea crystal can be removed, in a region in which the exhaust gas temperature is equal to or lower than an temperature Tₒ at which the urea crystal is removed.

In step 5, the control unit 38 estimates an accumulation amount of the urea crystal that remains in the exhaust system, by utilizing a formula such as “accumulation amount=accumulation amount−to-be-removed amount”.

In step 6, the control unit 38 determines whether or not the accumulation amount of the urea crystal is equal to or greater than a predetermined amount. The “predetermined amount” is a threshold for use in determining whether or not to forcefully remove the urea crystal accumulated in the exhaust system. For instance, the predetermined amount is set to be slightly smaller than an allowable accumulation amount up to which the exhaust system is able to tolerate the accumulation of the urea crystal. Then, when determining that the accumulation amount of the urea crystal is equal to or greater than the predetermined amount, the control unit 38 proceeds the process to step 7 (Yes), but when determining that the accumulation amount of the urea crystal is less than the predetermined amount, the control unit 38 terminates the process (No).

In step 7, in order to alarm that the urea crystal accumulated in the exhaust system is being forcefully removed, the control unit 38 controls the alarming lamp 44 attached to the instrument cluster to be lightened. In place of the alarming lamp 44, another alarm such as a buzzer may be activated.

In step 8, in order to forcefully remove the urea crystal accumulated in the exhaust system by raising the exhaust gas temperature above the temperature at which the urea crystal is removed, the control unit 38 outputs a command for increasing the fuel feeding amount to the fuel injection device attached to the diesel engine 10. In order to raise the exhaust gas temperature, the control unit 38 may perform a known forceful removing processing such as a control to open or close an intake air shutter or an exhaust shutter, a vane opening control of a variable turbo charger or a post injection control.

In the above-described exhaust purification apparatus, the exhaust of the diesel engine 10 passes through the exhaust manifold 22 and the turbine 18B of the turbo charger 18 to be introduced into the DOC converter 26A of the continuously regenerating DPF device 26. The exhaust having been introduced into the DOC converter 26A flows into the DPF 26B while NO contained therein is being partially oxidized to NO₂. In the DPF 26B, the PM in the exhaust gas is collected and eliminated, and the PM is oxidized with use of the NO₂ generated by the DOC converter 26A. In this manner, the collecting and eliminating of the PM and the regenerating of the PM are simultaneously performed.

The urea aqueous solution injected from the reducing agent injection device 28 at a flow rate that corresponds to the engine operating condition is hydrolyzed with use of the exhaust gas heat and the vapor in the exhaust gas, and converted into ammonia to serve as the reducing agent. In the SCR converter 30, this ammonia causes a selective reduction reaction with NO contained in the exhaust gas. As is known, the ammonia is then purified to be water (H₂O) and nitrogen gas (N₂), i.e., harmless components. On the other hand, the ammonia that has passed through the SCR converter 30 is to be oxidized by the oxidation catalyst converter 32 located at the exhaust downstream side of the SCR converter 30. Accordingly, the ammonia is prevented from being outlet into the atmosphere in its direct form.

According to the exhaust purification process described above, the accumulation amount of the urea crystal accumulated in the exhaust system, which is located at the exhaust downstream side of the point at which the urea aqueous solution is injected, can be estimated by: sequentially integrating the precipitation amount of the urea crystal estimated from the dosing flow rate of the urea aqueous solution and the exhaust gas temperature; and sequentially subtracting from the obtained integrated value the amount of the urea crystal to be removed that corresponds to the exhaust gas temperature. The urea crystal accumulated in the exhaust system decreases in the region in which the exhaust gas temperature is higher than the temperature at which the urea crystal is removed. Thus, with the attentions paid to this characteristic, by taking into account not only the deposition amount of the urea crystal but also the amount of the urea crystal to be removed, the accumulation amount of the urea crystal is estimated with high precision. Then, when the accumulation amount of the urea crystal becomes equal to or greater than the predetermined amount, the alarming lamp 44 attached to the instrument cluster is lightened, and the urea crystal is forcefully removed.

The accumulation amount of the urea crystal accumulated in the exhaust system, which is located at the exhaust downstream side of the point at which the urea aqueous solution is injected, may be configured to be written by the control unit 38 into the nonvolatile memory at the time when the engine is stopped, and the accumulation amount of the urea crystal may be configured to be read from the nonvolatile memory at the time when the engine is activated. With this arrangement, the accumulation amount of the urea crystal is prevented from being reset when the engine is stopped, and the value having been thus far calculated is retained for the subsequent uses. Therefore, reduction in the precision for the estimation of the accumulation amount of the urea crystal is suppressed.

Furthermore, considering that the SCR converter 30 and the oxidation catalyst converter 32 are subjected to inspection, cleaning and the like, at maintenance factories, the exhaust purification apparatus may be configured to have a function that forcefully resets the accumulation amount of the urea crystal in response to external instructions. Moreover, the forceful removing processing of the urea crystal may not be automatically performed, but may be instead configured to be performed in response to an instruction by a driver or the like who has noticed the lightening of the alarming lamp 44.

### REFERENCE SIGNS LIST

10: diesel engine

24: exhaust pipe

28: reducing agent injection device

30: SCR converter

36: temperature sensor

38: control unit

40: revolution speed sensor

42: load sensor

44: alarming lamp

1. An exhaust purification apparatus for an engine, comprising:
a selective catalytic reduction converter provided to an exhaust pipe of the engine and adapted to selectively reduce and purify nitrogen oxide with use of ammonium generated from a urea aqueous solution;
a reducing agent injection device adapted to inject the urea aqueous solution to the exhaust gas that flows at the exhaust upstream side of the selective catalytic reduction converter at a flow rate that corresponds to an engine operating condition;
a temperature sensor adapted to measure a temperature of exhaust gas that flows at the exhaust upstream side of the reducing agent injection device; and
a control unit having a built-in computer, wherein the control unit
estimates a deposition amount of urea crystal to be deposited in an exhaust system per unit time, based on the exhaust gas temperature measured by the temperature sensor and the flow rate of the urea aqueous solution injected by the reducing agent injection device, the exhaust system being positioned at the exhaust downstream side of an injecting point of the urea aqueous solution,
estimates an amount of the urea crystal to be removed from the exhaust system per unit time, based on the exhaust gas temperature measured by the temperature sensor, and
estimates an accumulation amount of the urea crystal accumulated in the exhaust system, based on the deposition amount and the amount of the urea crystal to be removed per unit time.

2. The exhaust purification apparatus for an engine, according to claim 1, wherein the control unit further determines that a timing to forcefully remove the urea crystal accumulated in the exhaust system has arrived, when the accumulation amount of the urea crystal is equal to or greater than a predetermined amount.

3. The exhaust purification apparatus for an engine, according to claim 2, wherein the control unit further activates an alarm when determining that the timing to forcefully remove the urea crystal has arrived.

4. The exhaust purification apparatus for an engine, according to claim 2, wherein the control unit further performs a forceful removing processing when determining that the timing to forcefully remove the urea crystal has arrived, the forceful removing processing including raising a temperature of the exhaust gas that flows into the exhaust system above an temperature at which the urea crystal is removed.

5. The exhaust purification apparatus for an engine, according to claim 1, wherein the control unit further writes into a nonvolatile memory the accumulation amount of the urea crystal when the engine is stopped, and reads the accumulation amount of the urea crystal from the nonvolatile memory when the engine is activated.

6. The exhaust purification apparatus for an engine, according to claim 1, wherein the control unit further forcefully resets the accumulation amount of the urea crystal in response to an external instruction.

7. The exhaust purification for an engine for an engine, according to claim 1, wherein the control unit estimates the deposition amount of the urea crystal by referencing to a first map that sets out deposition amounts of the urea crystal corresponding to exhaust gas temperatures and injection flow rates of the urea aqueous solution.

8. The exhaust purification for an engine for an engine, according to claim 1, wherein the control unit estimates the amount of the urea crystal to be removed by referencing to a second map that sets out amounts of the urea crystal to be removed corresponding to exhaust gas temperatures.

9. The exhaust purification for an engine for an engine, according to claim 1, wherein the control unit estimates the accumulation amount of the urea crystal by: sequentially integrating the deposition amount of the urea crystal per unit time; and sequentially subtracting from the obtained integrated value the amount of the urea crystal to be removed per unit time.
